(19) United States
(12) Patent Application Publication
(10) Pub. No.: US 2006/0119286 A1
(43) Pub. Date: Jun. 8, 2006

(54) Lamp driving topology with current balancing scheme

(76) Inventors: Shih-Chung Huang, Taipei (TW); Tzu-Ming Yu, Taipei (TW)

Correspondence Address: RAYMOND Y. CHAN, 108 N. YNEZ AVE., SUITE 128, MONTEREY PARK, CA, 91754, US

(21) Appl. No.: 11/006,258

(22) Filed: Dec. 6, 2004

(51) Int. Cl. H05B 41/36; H05B 39/04

(52) U.S. Cl. 315/291

(57) ABSTRACT

A lamp driving system includes a transformer, a first impedance network coupled in series to a second impedance network, and a first load coupled in series to a second load. The second impedance network has a larger impedance value with respect to the first impedance network and the first and second impedance networks coupled in parallel to a secondary side of the transformer. The first load is coupled in parallel to the first impedance network and a series of the second load and a blocking impedance network is coupled in parallel to the second impedance network, wherein the larger impedance value of the second impedance network compared to the first impedance network causes the second load to operate before the first load, and the blocking impedance network is adjusted to achieve the current balance of the first load and the second load by changing an impedance value of the blocking impedance network.

### BACKGROUND OF THE PRESENT INVENTION

1. Field of Invention

The present invention relates to a multiple CCFL current balancing scheme and a multiple CCFL start circuit, and more particularly to a system for driving lamp loads connected in series and delivering evenly distributed current to each CCFL in a multiple CCFL system.

2. Description of Related Arts

Fluorescent lamps are used to provide illumination for general lighting purposes. The critical factors in the design of a cold cathode fluorescent lamp (CCFL) include efficiency, cost, and size. CCFLs (cold cathode fluorescent lamps) are wildly employed in display panels. Generally speaking, CCFLs require approximately 1500 Volts (RMS) to strike, and require approximately 800 Volts (RMS) for steady state operation. In displays where two CCFLs are required, a conventional technique is couple the lamps in parallel with the secondary side of a step-up transformer. In multiple lamp systems, the conventional technique for driving the lamps is to couple the lamps together in parallel with one another to the transformer. While this ensures voltage control during striking, this topology also requires impedance matching circuitry for the lamps. Also, current control in this topology is difficult since the current conditions of each lamp must be monitored.

FIG. 1 shows a conventional multiple lamp circuit having two CCFLs coupled in parallel, which includes a power supply 101, a step-up transformer 102, a first blocking capacitor 103, a second blocking capacitor 104, a first CCFL 105, and a second CCFL 106. The power supply 101 is coupled to a primary side of the step-up transformer 102. The first blocking capacitor 103 is coupled in series with the first CCFL 105. The second blocking capacitor 104 is coupled in series with the second CCFL 106. The series-coupled circuitry of the first blocking capacitor 103 and the first CCFL 105 is coupled in parallel with the series-coupled circuitry of the second blocking capacitor 104 and the second CCFL 106. The first blocking capacitor 103 and the second blocking capacitor 104 are coupled at a node 107. The other ends of the first CCFL 105 and the second CCFL 106 are grounded. The node 107 is coupled to a secondary side of the step-up transformer 102. The power supply 101 provides a voltage to the step-up transformer 102. The step-up transformer 102 delivers a step-up power source for the loads the first CCFL 105 and the second CCFL 106.

CCFLs require approximately 1500 Vrms for striking, and then approximately 800 Vrms for operating voltage. Initially, a striking voltage must be applied to the secondary side of the step-up transformer 102. During the striking process, the first CCFL 105 or the second CCFL 106 receives a majority of this striking voltage because the impedance of the first CCFL 105 or the second CCFL 106 is much greater than the impedance of the first blocking capacitor 103 or the second blocking capacitor 104. Assuming that the first CCFL 105 is struck first, there is an operational voltage of approximately 800 Vrms across the first CCFL 105. Accordingly, the step-up transformer 102 needs to supply an additional striking voltage for the second CCFL 106. Actually, these currents that flow into the lamps are similar but not equal due to the fact that the resistance of each path is somewhat different. This scheme does not have the capability of current balancing to control used to supply each CCFL.

Accordingly, it is desirable to couple in series since current control for series-connected lamps is idealized. However, connecting lamps in series requires the transformer to deliver a multiple of striking voltage for each lamp. This is obviously untenable since most transformers are incapable of providing 3000 Vrms for striking, or are expensive. Thus, there is a need to provide a lamp driving system that can drive two lamps coupled in series without straining the transformer to develop double the striking voltage.

A conventional technique providing a lamp driving system that can drive two lamps coupled in series without straining the transformer to develop double the striking voltage is shown in U.S. Pat. No. 6,559,606. In this patent, the system employs a high impedance network and a low impedance network. Additionally, the low impedance network is phase shifted with respect to the high impedance network. The high impedance network comprises real components (resistance), and the low impedance network is composed of real and reactive components, or purely reactive components, provided that there exists an overall phase difference between the high impedance network and the low impedance network. Since there is an impedance difference between the high impedance network and the low impedance network, the drawback of this prior art is the current unbalance between in two lamps. Hence the system for driving lamp loads connected in series could not deliver evenly distributed current to each CCFL in a multiple CCFL system even though this prior art has no need to double the voltage output from the transformer.

### SUMMARY OF THE PRESENT INVENTION

A main object of the present invention is to provide a load driving system that permits two loads connected in series without doubling the voltage output of the transformer while delivering evenly distributed current to each load in a multiple load system.

Another object of the present invention is to provide a load driving system that is adapted to deliver evenly distributed current to each load in a multiple load system by changing an impedance value of the blocking impedance network.

Another object of the present invention is to provide a load driving system, wherein the impedance difference between the first and second impedance networks generates a selected sequence of initial voltage to strike the first and second loads, and the blocking impedance network is adjusted to achieve the current balance of the first load and the second load by changing an impedance value of the blocking impedance network.

Another object of the present invention is to provide a load driving system, wherein the larger impedance value of the second impedance network compared to the first impedance network causes the second load to strike before the first load, and the blocking impedance network is adjusted to achieve the current balance of the first load and the second load by changing an impedance value of the blocking impedance network.

Accordingly, in order to accomplish the one or some or all above objects, the present invention provides a load driving system, comprising:

a power source;

a first impedance network and a second impedance network coupled in series, wherein the first and second impedance networks have different impedance values and are coupled in parallel to the power source;

a blocking impedance network; and

a first load and a second load coupled in series, wherein the first load is coupled in parallel to the first impedance network and a series of the second load and the blocking impedance network is coupled in parallel to the second impedance network,

wherein an impedance difference between the first and second impedance values of the first and second impedance networks generates a selected sequence of initial voltage to strike the first and second loads,

wherein the blocking impedance network is adjusted to achieve the current balance of the first load and the second load by changing an impedance value of the blocking impedance network.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 is a schematic diagram of a conventional multiple lamp circuit having two CCFLs in parallel.

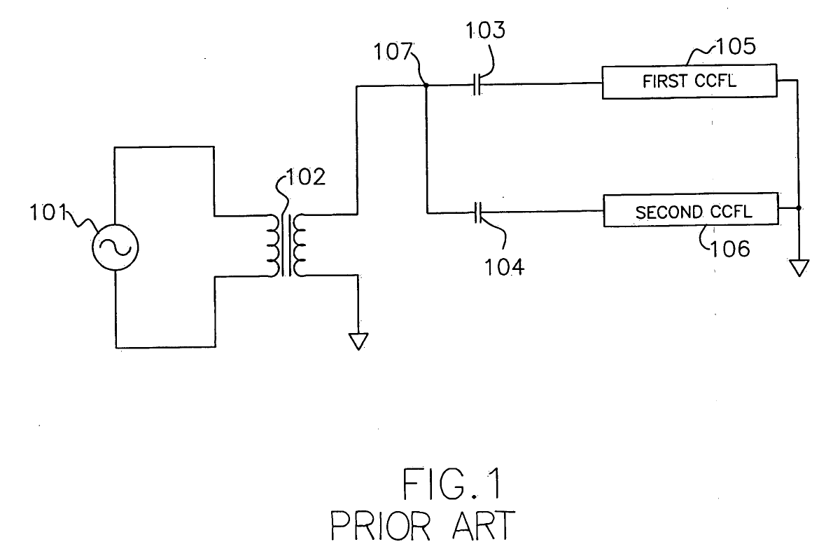

FIG. 2 is an exemplary circuit diagram of a lamp driving system according to a preferred embodiment of the present invention.

FIG. 3 is an exemplary circuit diagram of a load driving system 300 of the lamp driving system 200 of FIG. 2.

### DETAILED DESCRIPTION OF PREFERRED EMBODIMENT

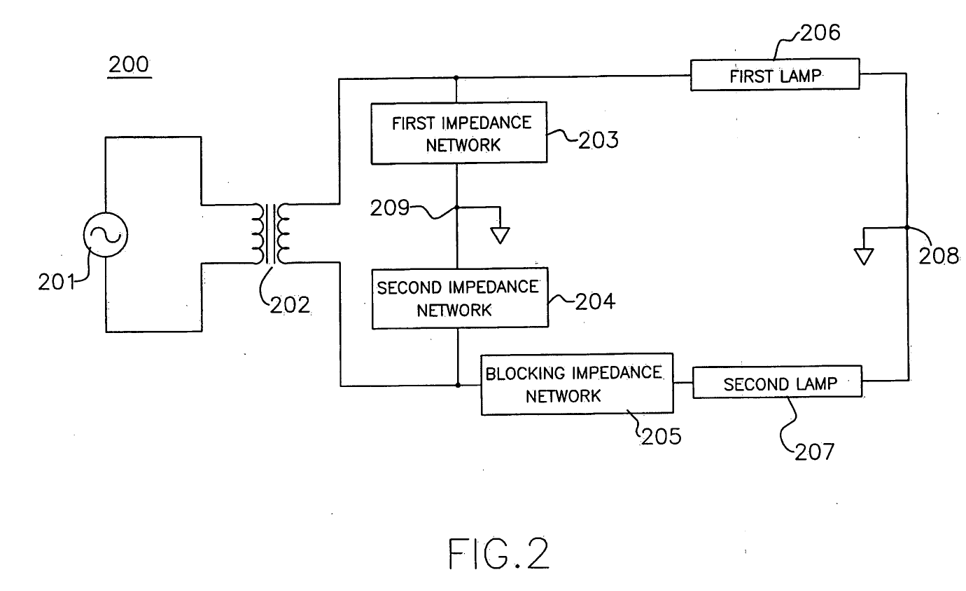

Referring to FIG. 2, an exemplary circuit diagram of a load driving system 200 according to a preferred embodiment of the present invention is illustrated. The load driving system 200 includes a power supply 201, a step-up transformer 202, a first impedance network 203, a second impedance network 204, a blocking network 205, and two loads 206, 207.

According to the preferred embodiment, the load driving system 200 is embodied as an exemplary lamp driving system, wherein the two loads in this exemplary embodiment are a first lamp 206 and a second lamp 207 connected in series. However, the present invention is to be broadly constructed to cover any particular load.

The power supply 201 is coupled to a primary side of the step-up transformer 202. The step-up transformer 202 delivers a step-up power source for the loads, the first lamp 206 and the second lamp 207. In the following description, the transformer 202 will be generically referred as a power source, and should be broadly constructed as such. Those skilled in art should recognize that conventional inverter topologies may be used to drive the primary side of the step-up transformer 202. Such inverter topologies include push-pull, Royer, half bridge, full bridge, etc., and all such inventers may be used with the lamp driving system 200 of the present invention. As an overview, the system 200 depicted herein permits two lamps to be connected in series without requiring double the voltage output of the secondary side of the step-up transformer 202.

According to the preferred embodiment of the present invention, the two lamps 206, 207 are embodied as cold cathode fluorescent lamps (CCFLs). It is appreciated that the present invention is applicable to any type of load such as cold cathode fluorescent lamps, metal halide lamps, sodium vapor lamps, x-ray tubes, and External Electrode Fluorescent Lamps.

The first impedance network 203 is coupled in series to the second impedance network 204. These two impedance networks together are coupled in parallel to the secondary side of the step-up transformer 202. Two lamps 206 and 207 are coupled in series to each other. The blocking impedance network 205 is coupled in series to one end of the second lamp 207. The two lamps 206, 207 and the blocking impedance network 205 together are coupled in parallel to the secondary side of the step-up transformer 202. The first lamp 206 is in parallel across the first impedance network 203. The second lamp 207 and the blocking impedance network 205 are together in parallel across the second impedance network 204. The common node 208 of the first lamp 206 and the second lamp 207 is grounded. The common node 209 of the first impedance network 203 and the second impedance network 204 is grounded. It is understood that the voltage and current feedback circuitry would be generally utilized to adjust the voltage and power delivered by the step-up transformer.

In this present invention, the impedance value of the second impedance network 204 is smaller than the impedance value of the first impedance network 203. Additionally, the first impedance network 203 and the second impedance network 204 are phase shifted to each other. The first impedance network 203 comprises purely real components, real and reactive components, or purely reactive components. The second impedance network 204 also comprises purely real components, real and reactive components, or purely reactive components.

Lamp Striking and Operational Sequence

To operate the lamp driving system 200, CCFL requires a striking voltage of approximately 1500 Vrms and a subsequent operational voltage of approximately 800 Vrms. Initially, the striking voltage is applied to the secondary side of the step-up transformer 202. The capacitor 204 receives a majority of this voltage because the impedance value of the second impedance 204 is smaller than the impedance value of the first impedance network 203. At this moment, the second impedance network 204 is coupled in parallel with the blocking impedance network 205 and the second lamp 207 through the ground. The voltage across the second impedance network 204 is approximately equal to the voltage across the second lamp 207 because the impedance of the second lamp 207 tends to the infinite and is much greater than the impedance of the blocking impedance network 205 before the second lamp 207 is struck.

Hence the voltage across the second impedance network 204 is employed to strike the second lamp 207. Since the second lamp 207 is already struck, there is an operational voltage across the second lamp 207. Once the second lamp 207 is already struck, the impedance of the second lamp 207 is much smaller than the impedance of the first impedance network 203. Therefore, the step-up transformer 202 delivers a majority of this striking voltage to the first impedance network 203. The first lamp 206 is coupled in parallel with the first impedance 203. The voltage across the first impedance network 203 is employed to strike the first lamp 206. The second impedance network 204 may provide a return path for the first lamp 206. The second lamp 207 and the blocking impedance network 205 may also provide a return path for the first lamp 206.

The impedance difference between the first lamp 206 and the second lamp 207 ensures a desired striking sequence. In the system 200 according to the preferred embodiment, the second lamp 207 strikes first. Thus, to ensure a striking sequence between the first lamp 206 and the second lamp 207, qualitatively the impedance values of the two networks are selected such that the second impedance network 204 initially receives a majority of the voltage delivered by the transformer. However, the impedance value is also a function of operating frequency, and thus may be changed according to the frequency characteristics of the system 200. The larger the majority means the less voltage that must be developed by the transformer initially. The phase difference between the first impedance network 203 and the second impedance network 204 permits the present to operate two lamps in series without requiring double the voltage output from the transformer.

In the two lamp circuits, the lamp currents are not equal due to the different impedance values of the first impedance network 203 and the second impedance network 204. This issue causes a difference in the amount of current available for each lamp and a resultant mismatch. The present invention employs the blocking impedance network 205 in order to deliver evenly distributed current to each lamp in a multiple lamp system. The total impedance value of the second impedance 204, the blocking impedance network 205, and the second lamp 207 may be adjusted to achieve the current balance of the first lamp 206 and the second lamp 207 by changing an impedance value of the blocking impedance network 205. Therefore, the lamp currents are equal due to the adjustment of the blocking impedance network 205.

Best Mode Implementation

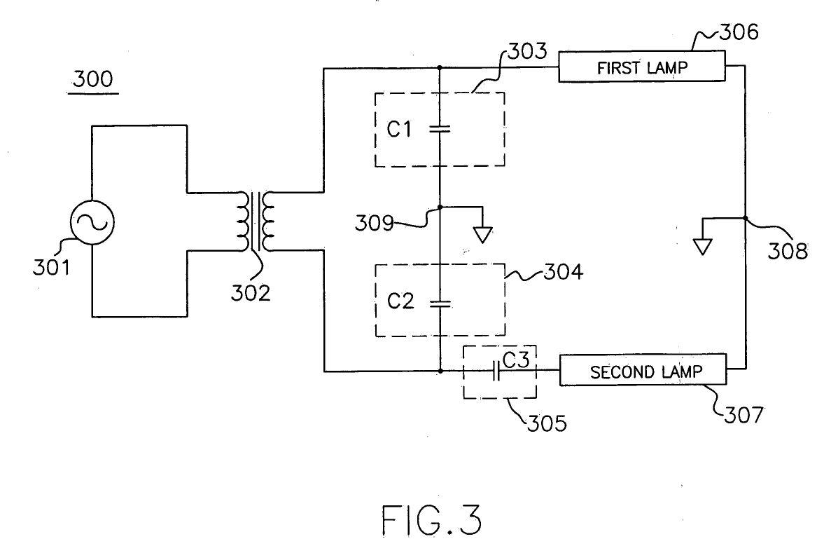

FIG. 3 is an exemplary circuit diagram of a load driving system 300 of the lamp driving system 200 of FIG. 2. More specifically, the system 300 is an exemplary lamp driving system. The system 300 includes a power supply 301, a step-up transformer 302, a first impedance network 303, a second impedance network 304, a blocking impedance network 305, and two loads 306, 307.

According to the preferred embodiment of the present invention, the first impedance network 303 comprises a first capacitor C1. The second impedance network 304 comprises a second capacitor C2. The blocking impedance network 305 comprises a capacitor C3. The first capacitor C1 and the second capacitor C2 are high impedance capacitors and the capacitor C3 is a blocking capacitor. Also, the loads 306, 307 include a first lamp 306 and a second lamp 307 connected in series.

The operation of the system 300 is set forth in the above-description of the system 200 in board terms. Specific operation of the system 300, by inspection, is as follows. As shown in FIG. 3, the striking voltage is given by the equation:

$${V}_{o} = {V}_{striking voltage} ⋆ ( \frac{- {jX}_{C 1} - {jX}_{C 2}}{- {jX}_{C 2}} ) = {V}_{striking voltage} ⋆ ( \frac{{X}_{C 1} + {X}_{C 2}}{{X}_{C 2}} ) \qquad Eq . 1$$

Where X_{C1} is the impedance value of the first capacitor C1, X_{C2} is the impedance value of the second capacitor C2, and Vₒ is output voltage of the transformer.

As shown in Eq. 1, since there is an impedance difference between the first capacitor C1 and the second capacitor C2, the system 300 depicted herein does not need to double the voltage output of the secondary side of the step-up transformer 302.

In operation of the lamp driving system 300, initially, a striking voltage is applied to the secondary side of the step-up transformer 302. The second capacitor C2 receives a majority of this voltage because the impedance value of the second capacitor C2 is larger than the impedance value of the first capacitor C1. At this moment, the second capacitor C2 is coupled in parallel with the blocking capacitor C3 and the second lamp 307 through the ground. The voltage across the second capacitor C2 is approximately equal to the voltage across the second lamp 307 because the impedance value of the second lamp 307 tends to the infinite and is much greater than the impedance value of the blocking capacitor C3 before the second lamp 307 is struck.

Hence, the voltage across the second capacitor C2 is employed to strike the second lamp 307. Since the second lamp 307 is already struck, there is an operational voltage across the second lamp 307. Once the second lamp 307 is already struck, the impedance value of the second lamp 307 is much smaller than the impedance value of the first capacitor C1. Therefore, the step-up transformer 302 delivers a majority of this striking voltage to the first capacitor C1. The first lamp 306 is coupled in parallel with the first capacitor C1. The voltage across the first capacitor C1 is employed to strike the first lamp 306.

In the two lamp circuits, the lamp currents are not equal due to the different impedance values of the first capacitor C1 and the second capacitor C2. This issue causes a difference in the amount of current available for each lamp and a resultant mismatch. The present invention employs the blocking capacitor C3 in order to deliver evenly distributed current to each lamp in a multiple lamp system. The total impedance value of the second capacitor C2, the blocking capacitor C3, and the second lamp 307 may be adjusted to achieve the current balance of the first lamp 306 and the second lamp 307 by changing the impedance value of the blocking capacitor C3. Therefore, the lamp currents could be equal due to the adjustment of the blocking capacitor C3.

The above embodiment as shown in FIG. 3 uses the high impedance capacitors 303, 304 and the blocking capacitor 305 to illustrate the invention. Nevertheless, the impedance network of this invention and the blocking impedance network are not limited to high impedance capacitors and the blocking capacitor. The high impedance network and blocking impedance network of this invention could be resistors and inductors. However, high impedance capacitors and the blocking capacitor are preferred embodiments of the invention that are presently best known to ensure the current balance of two lamps by changing the impedance value of the blocking impedance network.

The present invention employs the inverter connected to the primary side of the transformer capable of adjusting power delivered to the transformer based on the current and voltage feedback information (not shown), via an inverter controller. Such known inverter controllers generally use the feedback information to adjust a pulse width modulation switching scheme, such as provided by push-pull, Royer, half bridge and full bridge inverter topologies. Additionally, while the present invention makes specific reference to CCFLs, the present invention is equally applicable for driving many types of lamps and tubes known in the art, such as: metal halide lamps, sodium vapor lamps, and/or x-ray tubes.

One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A load driving system, comprising:
a power source;
a first impedance network having a first impedance value;
a second impedance network which has a second impedance value and is coupled in series to said first impedance network, wherein said first and second impedance networks are coupled in parallel to said power source; and
a blocking impedance network; and
a first load and a second load coupled in series to said first load, wherein said first load is coupled in parallel to said first impedance network and a series of said second load and said blocking impedance network is coupled in parallel to said second impedance network, wherein said blocking impedance network is adjusted to achieve a current balance of said first load and said second load by changing an impedance value of said blocking impedance network.

2. The load driving system, as recited in claim 1, wherein said first and second impedance values of said first and second impedance networks are different.

3. The load driving system, as recited in claim 2, wherein said second impedance value of said second impedance network is larger than said first impedance value of said first impedance network.

4. The load driving system, as recited in claim 1, wherein said first impedance network comprises a first capacitor and said second impedance network comprises a second capacitor.

5. The load driving system, as recited in claim 3, wherein said first impedance network comprises a first capacitor and said second impedance network comprises a second capacitor.

6. The load driving system, as recited in claim 1, wherein said second impedance network receives a majority of initial voltage provided by said power source to strike said second load first and said first impedance network receives a majority of voltage provided by said power source to strike said first load after said load is struck.

7. The load driving system, as recited in claim 3, wherein said second impedance network receives a majority of initial voltage provided by said power source to strike said second load and said first impedance network receives a majority of voltage provided by said power source to strike said first load after said load is struck.

8. The load driving system, as recited in claim 4, wherein said second impedance network receives a majority of initial voltage provided by said power source to strike said second load and said first impedance network receives a majority of voltage provided by said power source to strike said first load after said load is struck.

9. The load driving system, as recited in claim 5, wherein said second impedance network receives a majority of initial voltage provided by said power source to strike said second load and said first impedance network receives a majority of voltage provided by said power source to strike said first load after said load is struck.

10. The load driving system, as recited in claim 1, wherein said blocking impedance network comprises a capacitor.

11. The load driving system, as recited in claim 4, wherein said blocking impedance network comprises a capacitor.

12. The load driving system, as recited in claim 1, wherein said loads are selected from a group consisting of cold cathode fluorescent lamps, metal halide lamps, sodium vapor lamps, x-ray tubes, and External Electrode Fluorescent Lamps.

13. The load driving system, as recited in claim 1, wherein said first and second impedance networks are selected from a group consisting of resistors, inductors, and capacitors.

14. A lamp driving system, comprising:
a power supply;
a transformer having a first side connected to said power supply and a secondary side;
a first impedance network having a first impedance value;
a second impedance network which has a second impedance value and is coupled in series to said first impedance network, wherein said second impedance value is larger than said first impedance value and said first and second impedance networks are coupled in parallel to said secondary side of said transformer;
a blocking impedance network; and
a first load and a second load coupled in series to said first load, wherein said first load is coupled in parallel to said first impedance network and a series of said second load and said blocking impedance network is coupled in parallel to said second impedance network,
wherein said second impedance value of said second impedance network compared to said first impedance network causes said second load to strike before said first load, and said blocking impedance network is adjusted to achieve a current balance of said first load and said second load by changing an impedance value of said blocking impedance network.

15. The lamp driving system, as recited in claim 14, wherein said first impedance network comprises a first capacitor and said second impedance network comprises a second capacitor.

16. The lamp driving system, as recited in claim 14, wherein said blocking impedance network comprises a capacitor.

17. The lamp driving system, as recited in claim 15, wherein said blocking impedance network comprises a capacitor.

18. The lamp driving system, as recited in claim 14, wherein said second impedance network receives a majority of initial voltage provided by said transformer to strike said second lamp first and said first impedance network receives a majority of voltage provided by said transformer to strike said first lamp after said second lamp is struck.

19. The lamp driving system, as recited in claim 15, wherein said second impedance network receives a majority of initial voltage provided by said transformer to strike said second lamp first and said first impedance network receives a majority of voltage provided by said transformer to strike said first lamp after said second lamp is struck.

20. The lamp driving system, as recited in claim 17, wherein said second impedance network receives a majority of initial voltage provided by said transformer to strike said second lamp first and said first impedance network receives a majority of voltage provided by said transformer to strike said first lamp after said second lamp is struck.

21. The lamp driving system, as recited in claim 14, wherein said second impedance network receives a majority of initial voltage provided by said transformer and said second lamp is struck first with a lamp striking voltage, wherein said second lamp receives an operational voltage less than said striking voltage and said first impedance network receives a majority of voltage provided by said transformer to strike said first lamp after said second lamp is struck.

22. The lamp driving system, as recited in claim 14, wherein lamps are selected from a group consisting of cold cathode fluorescent lamps, metal halide lamps, sodium vapor lamps, x-ray tubes, and External Electrode Fluorescent Lamps.

23. The lamp driving system, as recited in claim 14, wherein said first and second impedance networks are selected from a group consisting of resistors, inductors, and capacitors.

24. A circuit, comprising:
a first impedance network and a second impedance network coupled in series to said first impedance network;
a blocking impedance network; and
a first load and a second load coupled in series to said first load, wherein said first load is coupled in parallel to said first impedance network and a series of said second load and said blocking impedance network is coupled in parallel to said second impedance network, wherein said blocking impedance network is adjusted to achieve a current balance of said first load and said second load by changing an impedance value of said blocking impedance network.

25. A circuit, comprising:
a first impedance network and a second impedance network coupled in series to said first impedance network, wherein said second impedance network has a larger impedance value than that of said first impedance network;
a blocking impedance network; and
a first load and a second load coupled in series to said first load, wherein said first load is coupled in parallel to said first impedance network and a series of said second load and said blocking impedance network is coupled in parallel to said second impedance network, wherein said larger impedance value of said second impedance network compared to said first impedance network causes said second load to operate before said first load, and said blocking impedance network is adjusted to achieve a current balance of said first load and said second load by changing an impedance value of said blocking impedance network.
